(19) United States
(12) Patent Application Publication
(10) Pub. No.: US 2026/0116549 A1
(43) Pub. Date: Apr. 30, 2026

(54) IMPACT- AND BLAST-RESISTANT AIRCRAFT SEAT

(71) Applicant: Michael Cohen, Kefar Ezyon (IL)

(72) Inventor: Michael Cohen, Kefar Ezyon (IL)

(21) Appl. No.: 18/923,287

(22) Filed: Oct. 22, 2024

(30) Foreign Application Priority Data
Oct. 22, 2023 (IL) 307932

(51) Int. Cl. B64D 25/04; B64D 11/06; B64D 25/06; B64D 25/10; F41H 5/04

(52) U.S. Cl. CPC B64D 25/04; B64D 11/0689; B64D 25/06; B64D 25/10; F41H 5/0492

(57) ABSTRACT

This invention provides, in some embodiments, an impact- and blast-resistance improved aircraft pilot chair, which is able to provide improved protection to a pilot, from exposure to significant G forces and/or exposure to projectiles including projectiles penetrating the aircraft and/or effects of pilot chair ejection and/or effects of aircraft crash

### CROSS-REFERENCE TO RELATED APPLICATIONS

This application claims priority to IL 307932, filed Oct. 22, 2023.

### BACKGROUND OF THE INVENTION

Piloting modern aircraft poses new challenges, which increase the threat to the health and safety of these brave men and women. In addition to the traditional risks, which every pilot faces, of the threat of crash landings, today's reality imposes a growing need to also protect the pilot from the threat of projectiles directed at the aircraft.

Arrangements for removing an occupant or other load from a vehicle such as an aircraft are well known. In these cases, a man-carrying seat may be catapulted to a point of separation from the vehicle. A rocket or other means launches the man away from the vehicle. The rocket is effective to provide a stable trajectory over the total speed range of the vehicle. The seat and the man are maintained in their initial ejected position. After burn out of the propelling rocket, the seat and crew member soon reach the apogee of the ejection trajectory. At this time, the man separates from the seat and thereafter assumes normal parachute descent to the earth.

In the development of ejection seats, great emphasis has been placed on the actual structure of the seat to make it as light as possible while still maintaining high structural strength. Also, with the lightweight and high structural strength, it is desirable to have a seat which can accommodate a recovery parachute pack assembly, drogue packs or other items.

Rail and track arrangement provides means for distributing the stress of the seat during ejection operation. When the seat is ejected, however, the contact between the rail and track becomes less and less. This means that the stress on the smaller portions of rail and track become progressively greater as the seat is being ejected. Excessive stress on one point of the rail or track tends to produce distortion and possibly produce jamming during operation.

Conventional aluminum seats have numerous expensive small components, which contribute to excessive assembly time and increased cost. In addition, it is often difficult to form the complex geometry that might be preferred for interior styling.

Although composite seats are less expensive to assemble and can be used to form complex shapes, there is insufficient design data relating to crash/high-speed deformation environments. Also contributing to the lack of availability of crash test data is the fact that composites don't plastically deform-thus making crash reaction calculations difficult.

These are not the only impact related stresses facing aircraft pilots, however.

The excessive forces to which the piloting crew may be exposed include applied forces due to aerodynamic causes and mechanical causes.

The effect of these forces on the human body is clearly adverse, as even minor sustained vibrations through the pilot chair over time have a clear negative effect on the pilot occupying it, certainly the danger to life and limb is significant when exposure to significant forces occurs.

A number of solutions have been offered, to provide protection systems to be installed in the helicopter's pilot chair, but the solutions to date have not been ideal.

There unfortunately is no current solution to both offer protection to the pilot from impacting projectiles, while still providing protection from the deleterious effects of significant forces to which the pilot is subjected, in particular when related to impact-driven forces.

Thus there remains a need to arrive at impact- and blast-resistant aircraft seats, which more ideally protect the pilot and passengers, to ensure their survivability and overall health and well-being, in these most challenging modern times.

In addition, there remains a need to arrive at simple, lightweight, impact- and blast-resistant structures in general, which more ideally protect persons adjacent thereto, to ensure their survivability and overall health and well-being, as well, in these most challenging modern times.

### SUMMARY OF THE INVENTION

This invention provides, in some embodiments, an impact- and blast-resistance improved aircraft pilot chair, which is able to provide improved protection to a pilot, from exposure to significant G forces and/or exposure to projectiles including projectiles penetrating the aircraft and/or effects of pilot chair ejection and/or effects of aircraft crash.

Surprisingly, in developing the composite impact- and blast-resistance improved aircraft pilot chairs of this invention, for the first time it has been possible to arrive at a safety enhanced pilot chair that comfortably and safely secures the pilot within the chair, reducing pain and health hazards commonly felt among pilots when piloting aircraft, providing superior protection from G forces applied, in addition to for the first time providing a lighter weight solution with enhanced protection of the pilot, from impacting and penetrating projectiles in the aircraft.

Uniquely, as is described further hereinunder, experiments conducted demonstrated significant ability to for the framework structures of non-limiting examples of the aircraft pilot chairs of this invention to resist deformation, even when at least up to about 22,000 pounds of horizontal force, or at least up to about 10,000 pounds of vertical force were applied.

In one embodiment, this invention provides an impact- and blast-resistance improved aircraft pilot chair, able to resist structural compromise, such as deformation, even when at least up to about 22,000 pounds of horizontal force, or at least up to about 10,000 pounds of vertical force are applied, or in some aspects, when the aircraft is subject to an applied at least about 9 G of force, or in some aspects, providing protection to the pilot when exposed to enemy fire or projectile penetration of the aircraft, or any combination of these conditions.

In one embodiment, this invention provides an impact- and blast-resistance improved aircraft pilot chair, said chair comprising:
a. a composite chair framework structure serving as the scaffolding for the impact- and blast-resistance improved aircraft pilot chair, wherein said framework structure comprises a back support component, a seat component and a side protection component of said pilot chair, comprising;
   i. a first set of at least two beams posteriorly affixed to or forming a long axis of said chair frame, wherein each of said at least two beams are from 10-100 mm in width and from 0.5-20 mm thickness and said beams are positioned at a distance from each other, wherein said beams are comprised of steel, aluminum, titanium or a composite of same and wherein said first set of at least two beams constitutes a part of or is fixedly attached to said back support component; and
   ii. a second set of at least two beams positioned substantially perpendicularly with respect to said first set, wherein each of said at least two beams are from 10-100 mm in width and from 0.5-20 mm thickness and wherein a first beam of said second set is fixedly positioned at its terminus to abut or join a terminus of a first beam of said first set and a second beam of said second set is fixedly positioned at its terminus to abut or join a terminus of a second beam of said first set and wherein said second set of at least two beams constitutes a part of or is fixedly attached to said seat component; and
   iii. at least two strength reinforced elbow joints, each elbow joint fixing a first and second beam respectively of said first set of at least two beams to a first and second beam, respectively of said second set of at least two beams and maintaining said joint between the first and second beams respectively of said first set of beams and second set of beams substantially at an angle of about 90 degrees even under applied significant forces; and
   iv. laterally extending, angled side protection framework components, which loosely frame and facilitate attachment of side protective panels; and
b. composite armored element containing assemblies which are fixedly attached to said composite chair framework structure at least to a portion of the area of said back support component, seat component and side protection component of said pilot chair.

In some embodiments, the invention provides an aircraft comprising an impact- and blast-resistance improved aircraft pilot chair of this invention, including wherein the aircraft is a helicopter.

In some embodiments, the invention provides a method of improving the impact- and blast-resistance of an aircraft pilot chair, the method comprising equipping a pilot chair in the aircraft to comprise the impact- and blast-resistance improved aircraft pilot chair of this invention, including in any embodiment as described herein with respect to same, whereby impact resistance of said aircraft pilot chair is improved to withstand application of up to at least about 9 G of applied force, or in some aspects, up to at least about 22,000 pounds of horizontal force, or up to at least about 10,000 pounds of vertical force or a combination thereof.

In one embodiment, this invention provides an impact- and blast-resistance improved passive protection structure, said passive protection structure comprising:
a. a composite framework passive protection structure configured for facing an anticipated impact direction for reducing the damage and/or fatality associated with an incoming projectile, including, inter alia, reducing the damage and/or fatality associated with an impact or blast triggering of an incoming projectile, wherein said passive protection structure comprises:
   i. a first set of at least two beams forming a long axis of said frame, wherein each of said at least two beams are from 10-100 mm in width and from 0.5-20 mm thickness and said beams are positioned at a distance from each other, wherein said beams are comprised of steel, aluminum, titanium or a composite of same and wherein said first set of at least two beams constitutes a part of or is fixedly attached to said long axis of said frame component; and
   ii. a second set of at least two beams positioned substantially perpendicularly with respect to said first set, wherein each of said at least two beams are from 10-100 mm in width and from 0.5-20 mm thickness and wherein a first beam of said second set is fixedly positioned at its terminus to abut or join a terminus of a first beam of said first set and a second beam of said second set is fixedly positioned at its terminus to abut or join a terminus of a second beam of said first set and wherein said second set of at least two beams constitutes a part of or is fixedly attached to a static structure; and
   iii. at least two strength reinforced elbow joints, each elbow joint fixing a first and second beam respectively of said first set of at least two beams to a first and second beam, respectively of said second set of at least two beams and maintaining said joint between the first and second beams respectively of said first set of beams and second set of beams substantially at an angle of about 90 degrees even under applied significant forces; and
   iv. optionally laterally extending, angled protection framework components, which loosely frame the boundaries that the framework structure protects; and
b. optionally a composite armored layer containing assemblies positioned at a distance from said framework structure, providing further protection to anything located underneath the armored layer.

In some embodiments, the invention provides a method of improving the impact- and blast-resistance of a structure, the method comprising equipping the structure potentially exposed to a blast or penetrating impact to comprise the impact- and blast-resistance improved framework structure of this invention, including in any embodiment as described herein with respect to same.

The accompanying drawings, which are incorporated in and constitute a part of this specification, illustrate several non-limiting embodiments of the invention and together with the description, serve to explain some of the embodied principles of the invention.

With reference to the figures in detail, it is stressed that the particulars shown are by way of example and for purposes of illustrative discussion of certain embodiments of the present invention only, and are presented in the cause of providing what is believed to be useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may, be embodied in practice.

### BRIEF DESCRIPTION OF THE DRAWINGS

Various embodiments of the devices, systems and methods of this invention are described herein with reference to the figures wherein:

FIG. 1 schematically depicts a non-limiting example of an impact- and blast-resistance improved aircraft pilot chair.

FIG. 2 schematically depicts an exploded view of the non-limiting example of an impact- and blast-resistance improved aircraft pilot chair of FIG. 1.

FIG. 3 schematically depicts a magnified view of a non-limiting example of a joint region in the framework structure of an impact- and blast-resistance improved aircraft pilot chair of FIG. 1.

FIG. 4 schematically depicts a non-limiting example of a framework structure of an impact- and blast-resistance improved aircraft pilot chair of FIG. 1.

FIG. 5 schematically depicts a non-limiting example of a front view of a framework structure of an impact- and blast-resistance improved aircraft pilot chair.

FIG. 6A-6C schematically depicts a non-limiting example of a back view of a framework structure (6A) and back view of the minimal frame elements (6B) and front view of the minimal frame elements (6C) of an impact- and blast-resistance improved aircraft pilot chair.

FIG. 7 schematically depicts a non-limiting example of a filled in, front view of an impact- and blast-resistance improved aircraft pilot chair.

FIG. 8A-8D schematically depicts a non-limiting example of forces acting upon a non-limiting example of an impact- and blast-resistance improved aircraft pilot chair, representing some of the forces assessed in testing conducted as described further in the Examples.

FIG. 9A-9B are photographs of a non-limiting example of a blast- and impact-resistant chair of the invention, being subjected to test forces, as described herein in the Examples prior to and during the force application. No structural compromise whatsoever occurred to the chair.

FIG. 10 plots the results of the force applied to the chair over time. The experiment was halted following the application of more than 21,000 pounds of force as shown, since there was no structural compromise to the chair whatsoever and the applied force was far beyond the requirements.

FIG. 11 schematically depicts a non-limiting example of an impact- and blast-resistance improved aircraft pilot chair accommodating a pilot.

### DETAILED DESCRIPTION OF THE INVENTION

This invention provides, in some embodiments, a unique, impact- and blast-resistance improved aircraft pilot chair, which is able to provide improved protection to a pilot, from exposure to significant G forces and/or exposure to projectiles including projectiles penetrating the aircraft and/or effects of pilot chair ejection and/or effects of aircraft crash.

Surprisingly, in developing the composite impact- and blast-resistance improved aircraft pilot chairs of this invention, for the first time it has been possible to arrive at a safety enhanced pilot chair that comfortably and safely secures the pilot within the chair, reducing pain and health hazards commonly felt among pilots when piloting aircraft, providing superior protection from G forces applied, in addition to for the first time providing a lighter weight solution with enhanced protection of the pilot, from impacting and penetrating projectiles in the aircraft.

Uniquely, as is described further hereinunder, experiments conducted demonstrated significant ability to for the framework structures of non-limiting examples of the aircraft pilot chairs of this invention to resist deformation, even when at least up to about 22,000 pounds of horizontal force, or at least up to about 10,000 pounds of vertical force were applied.

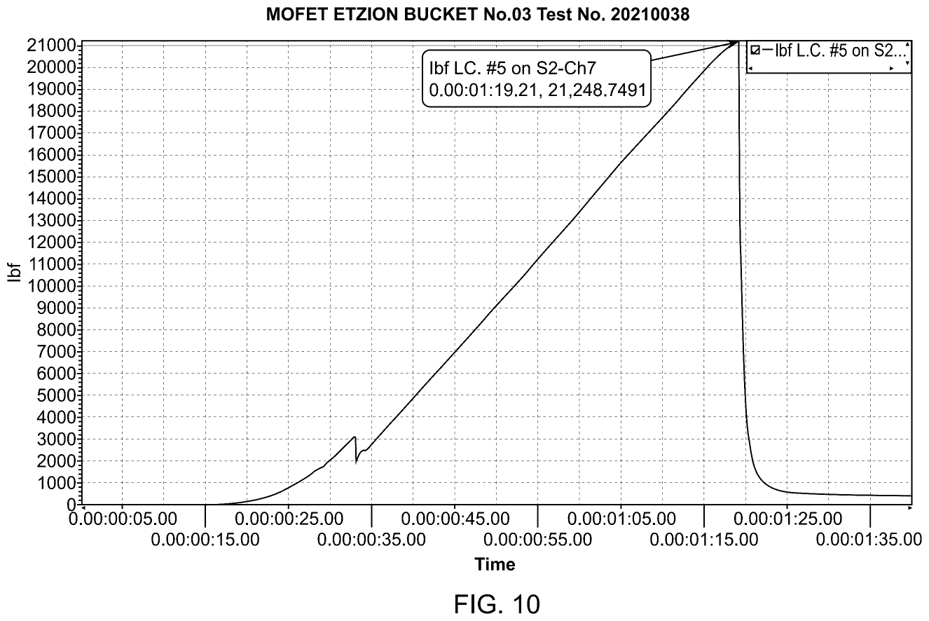

Surprisingly, as described and demonstrated herein, when testing was conducted on an embodied impact- and blast-resistance improved aircraft pilot chair of this invention, an applied force of more than 21,000 pounds by established testing methodology demonstrated no structural compromise to the chair, in an unprecedented finding (FIG. 10).

In one embodiment, this invention provides an impact- and blast-resistance improved aircraft pilot chair, able to resist structural compromise, such as deformation, even when at least up to about 22,000 pounds of horizontal force, or at least up to about 10,000 pounds of vertical force are applied, or in some aspects, when the aircraft is subject to an applied at least about 9 G of force, or in some aspects, providing protection to the pilot when exposed to enemy fire or projectile penetration of the aircraft, or any combination of these conditions.

In some embodiments, the invention provides an impact- and blast-resistance improved aircraft pilot chair, said chair comprising:
a. a composite chair framework structure serving as the scaffolding for the impact- and blast-resistance improved aircraft pilot chair, wherein said framework structure comprises a back support component, a seat component and a side protection component of said pilot chair, comprising;
i. a first set of at least two beams posteriorly affixed to or forming a long axis of said chair frame, wherein each of said at least two beams are from 10100 mm in width and from 0.5-20 mm thickness and said beams are positioned at a distance from each other, wherein said beams are comprised of steel, aluminum, titanium or a composite of same and wherein said first set of at least two beams constitutes a part of or is fixedly attached to said back support component; and
ii. a second set of at least two beams positioned substantially perpendicularly with respect to said first set, wherein each of said at least two beams are from 10-100 mm in width and from 0.5-20 mm thickness and wherein a first beam of said second set is fixedly positioned at its terminus to abut or join a terminus of a first beam of said first set and a second beam of said second set is fixedly positioned at its terminus to abut or join a terminus of a second beam of said first set and wherein said second set of at least two beams constitutes a part of or is fixedly attached to said seat component; and
   iii. at least two strength reinforced elbow joints, each elbow joint fixing a first and second beam respectively of said first set of at least two beams to a first and second beam, respectively of said second set of at least two beams and maintaining said joint between the first and second beams respectively of said first set of beams and second set of beams substantially at an angle of about 90 degrees even under applied significant forces; and
   iv. laterally extending, angled side protection framework components, which loosely frame and facilitate attachment of side protective panels; and
b. composite armored element containing assemblies which are fixedly attached to said composite chair framework structure at least to a portion of the area of said back support component, seat component and side protection component of said pilot chair.

In some embodiments, the reference to the term “impact- and blast-resistance improved aircraft pilot chair” refers to any appropriate seat for a pilot, or co-pilot, or member of the aircraft piloting team, whereby the structural components of the chair systems as herein described are included, but the seat/chair may comprise any other component, modification, etc. as known in the art.

By way of non-limiting example, many different coverings for aircraft seats/chairs are known to provide comfort and other necessary aspects for pilots and piloting crews and same could be readily incorporated in the chair systems of this invention.

It will be apparent to the skilled artisan that the elements as described with respect to the components of the impact- and blast-resistance improved aircraft pilot chair as described herein, will allow for at least these components, but in no way does this limit inclusion of other chair/seat components in any way.

This invention provides a strong, lightweight structure for enhanced occupant safety, involved in aircraft flight. In some aspects, the present invention seeks to achieve an appropriate combination of composite and metal parts in a way that meets current aircraft safety requirements while reducing weight of the components yet improving the occupant safety regarding the improved aircraft seat.

Embodiments of the present invention also seek to provide a seat which includes a portion having specialized core structure, which imparts the ability to dissipate energy and protect the occupant from penetrating projectiles/components of projectiles, which uniquely provided added protection to the seat occupant during a mishap, attack or crash, thereby further dissipating some of the force of the crash.

The skilled artisan will readily appreciate how to manufacture the embodied impact- and blast-resistance improved aircraft pilot chairs of this invention.

Embodiments of the present invention may be manufactured as original equipment, or alternatively may be manufactured in the nature of a retrofit. A goal of various embodiments of the present invention is to provide a seat which is relatively simple in design, easy to install, and which requires no substantial alteration of the cabin of the aircraft to accommodate installation.

An object of one embodiment of the present invention is to provide a seat having a force dissipation assembly which is lightweight, compact, efficient, and uniquely and singularly address the stated requirements for impact resistance to withstand application of at least up to about 9 G of applied force, or to withstand application of at least up to about 22,000 pounds of horizontal force, or at least up to about 10,000 pounds of vertical force or any combination thereof.

In some embodiments, the term “composite” generally refers to a material created by the macroscopic combination of two or more distinct materials to obtain specific characteristics and properties.

In some aspects, the reference to a composite structure refers to, in some aspects, combinations of materials, for example as part of the framework structure as herein described.

For example, and in some embodiments, the invention provides a framework structure serving as the scaffolding for the impact- and blast-resistance improved aircraft pilot chair, wherein said framework structure comprises a back support component, a seat component and a side protection component of said pilot chair.

According to this aspect and in some embodiments, the back support component, seat component and side protection components may be comprised of different materials from each other, or in some embodiments, each of the back support component, seat component and side protection component can be constituted of different materials, so that the back support component, seat component and side protection components are composite structures.

In some aspects, the first set of at least two beams posteriorly affixed to or forming a long axis of said chair frame, second set of at least two beams positioned substantially perpendicularly with respect to said first set, at least two strength reinforced elbow joints, laterally extending, angled side protection framework components or any combination thereof may be comprised of different materials from each other, or in some embodiments, may each represent a composite structure which may be constituted of the same or different materials.

It is to be understood that certain terms as used herein should be interpreted to suit the various descriptions and embodiments listed herein, and should be given an appropriately broad interpretation as will be clear from the context of use.

For example, and representing an intention regarding the use of such terms, the terms “connected”, “coupled” or “joined” and related terms are used in an operational sense and are not necessarily limited to a direct connection or coupling, although this is one interpreted meaning. It will be appreciated that connection via means of adaptors, connectors and other structural elements is clearly intended, and that any means to ensure operational coupling/connection is considered, unless it is clearly indicated that the connection of the two elements must be via direct linkage only.

In other aspects, representing an intention regarding the use of such terms, the terms “in one embodiment,” “according to one aspect,” and the like generally mean the particular feature, structure, or characteristic following the phrase is included in at least one embodiment of the present invention, and may be included in more than one embodiment of the present invention. Importantly, such phrases do not necessarily refer to the same embodiment.

In other aspects, representing an intention regarding the use of such terms, the terms as regarding a component or feature, stating “may”, “can”, “could”, or “might” be included or have a characteristic, that particular component or feature is not required to be included or have the characteristic.

The term “energy absorber” generally refers to any material or material form that absorbs dynamic energy without significant rebound following impact. Energy absorbing materials used in the context of this invention include, but are not limited to, aluminum, steel, titanium, Nomex™, carbon, Kevlar™ or viscoelastic materials as those sold by Oregon Aero, EAR Corp, 3M, and many others, as will be appreciated by the skilled artisan.

In some embodiments, the components of the framework structure, including for example, the back support component, seat component, side protection components, including in some aspects the first set of at least two beams posteriorly affixed to or forming a long axis of said chair frame, the second set of at least two beams positioned substantially perpendicularly with respect to said first set, the strength reinforced elbow joints, the laterally extending, angled side protection framework components or any combination thereof may comprise a metal or a composite comprising at least one metal component, as described herein.

In some embodiments, the term “metal” generally refers to, but is not limited to, common aerospace materials such as 2024, 6061, and 7075 aluminum in various tempers, steels such as 4130, 301, and 17-4PH, titanium and others, as will be appreciated by the skilled artisan.

In some aspects, the composite chair framework structures of this invention are termed “composite” structures, due to, at a minimum, a presence of the framework elements per se and the composite armored element containing assemblies which are fixedly attached to the composite chair framework structure.

In some aspects, the impact- and blast-resistance improved aircraft pilot chair framework structure comprises a first set of at least two beams posteriorly affixed to or forming a long axis of said chair frame, wherein each of said at least two beams are from 10-100 mm in width and from 0.5-20 mm thickness and said beams are positioned at a distance from each other.

It will be appreciated that the indicated width and thicknesses described refer to most commonly appropriate measurements, when considering the objectives to be achieved in the devices/systems/methods of this invention.

As will be appreciated by the skilled artisan, for each kilogram of added weight in a given aircraft pilot chair, there is a proportional cost in loss of fuel efficiency and/or cargo/load capacity. As described herein one of the unique and surprising findings of this invention is the ability to provide an impact- and blast-resistance improved aircraft pilot chair, which is a low-weight solution, while still withstanding up to at least about 9 G of applied force, etc.

Thus, it will be appreciated that the at least two beams are typically from about 10-100 mm in width, but this range can easily be modified as needed, for example, to from about at least 5-50 mm in width, or in some embodiments, to from about at least 10-25 mm in width, or in some embodiments, to from about at least 15-35 mm in width, or in some embodiments, to from about at least 15-50 mm in width, or in some embodiments, to from about at least 10-75 mm in width, or any suitable range that maintains the desired strength without adding too significant a weight to the framework structure.

Similarly, it will be appreciated that the at least two beams are typically from about 0.5-20 mm thickness, but this range can easily be modified as needed, for example, to from about at least 0.5-15 mm thickness, or in some embodiments, to from about at least 0.5-7 mm thickness, or in some embodiments, to from about at least 1-5 mm thickness, or in some embodiments, to from about at least 1-10 mm thickness, or in some embodiments, to from about at least 0.5-5 mm thickness, or in some embodiments, to from about at least 1-200 mm thickness, or in some embodiments, to from about at least 0.5-10 mm thickness, or any suitable range that maintains the desired strength without adding too significant a weight to the framework structure.

In some embodiments, it is noted that the exposure of the aircraft containing the impact- and blast-resistance improved aircraft pilot chair of this invention may be subject to significantly applied forces as indicated, wherein the application of force is very rapid in onset, such as following any structural compromise to the aircraft, or impact of the aircraft.

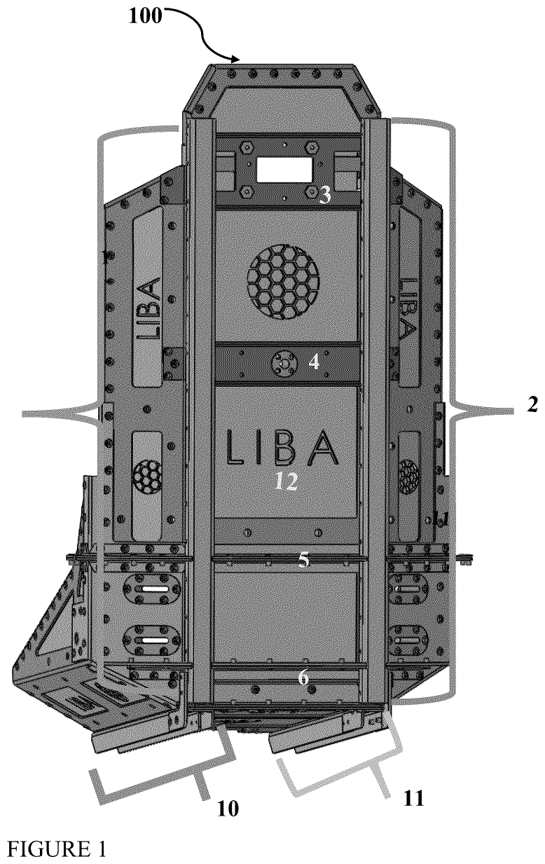

Referring to FIG. 1, representing an illustrative embodied aspect, such first set of beams can be understood to be illustratively presented as elements 1 and 2 in the figure.

In preferred aspects of the invention, the first set of beams (1,2) are comprised of steel, and in certain other preferred aspects, the beams may be comprised of aluminum, titanium or a composite of same, along with steel and wherein the first set of at least two beams constitutes a part of or is fixedly attached to the back support component. As will be appreciated, and as illustratively shown herein, for example, in FIGS. 1, 2, and 7-8, there are additional elements to the impact- and blast-resistance improved aircraft pilot chair beyond the framework structure, including additional components to provide support and comfort to components of the chair, and including additional components to the back support component of the chair, and reference to the first set of beams in no way derogates from the inclusion of these additional and even typical added components, such as stuffing, covering materials, and other elements, as will be appreciated by the skilled artisan.

In some embodiments, the first set of at least two beams posteriorly affixed to or forming a long axis of said chair frame form a U or similar shape.

The term “U” as described herein with regard to the described beam shape shall be understood to indicate a hollowed region in the beam, but that same does not limit the structure to be angled as opposed to somewhat or substantially rounded so that a substantially rectangular or substantially circular overall structure is implied, whereas the beams included may or may not comprise a fully solid beam but may comprise a somewhat hollowed region, that is still structurally sound and strong and able to promote withstanding the indicated force application.

In another aspect, the impact- and blast-resistance improved aircraft pilot chair framework structure further comprises a second set of at least two beams positioned substantially perpendicularly with respect to the first set. According to this aspect, and in some embodiments, each of the at least two beams are from 10-25 mm in width and from 0.5-7 mm thickness and wherein a first beam of said second set is fixedly positioned at its terminus to abut or join a terminus of a first beam of said first set and a second beam of said second set is fixedly positioned at its terminus to abut or join a terminus of a second beam of said first set and wherein the second set of at least two beams constitutes a part of or is fixedly attached to the seat component.

In some embodiments, the second set of at least two beams positioned substantially perpendicularly with respect to the first set forms a U or similar shape. In some aspects, the term “U” with regard to the shape will encompass any embodied aspect as herein described and the second set of beams, may comprise solid or hollowed beams as described herein with regard to the first set of beams, in any embodiment included in the description herein.

Referring for example, to FIG. 1, the second set of at least two beams (10, 11) are positioned substantially perpendicularly with respect to the first set of beams (1, 2), respectively. As will be apparent, from for example, FIGS. 1, 4, 7 and 8, whereas the first set of beams is associated with the back support, the second set of beams is associated with the seat support element.

It will be appreciated that reference to “back” and “seat” supports is use of conventional terminology as relating to the typical components with regard to the support provided to the occupant of the impact- and blast-resistance improved aircraft pilot chair, in that the first set of beams spanning substantially the long axis of the portion of the chair element most proximally and in contact with the back of the chair occupant, whereas the second set of beams provides support for the plate/element of the chair structure that provides a “seat” for the occupant to occupy in the aircraft.

It will be further appreciated that the reference to the “back” and “seat” supports and with regard to the first and second set of beams, are described herein as being positioned substantially perpendicularly, in other words, where by the back support and seat components will meet, so that these beams provide structural support and strengthened positions in the framework with respect thereto. In some embodiments, the angle between the back and seat support is not a perfect 90 degrees, and in some embodiments, the term “perpendicularly” will be understood to be a rough/approximation of the angle by which the two sets of beams respectively abut or join each other, but clearly allowing for further angling of the components, as permissible, for example to provide an adjusted angle to accommodate the needs and comfort of the seat occupant and to accommodate additional “tolerance” regarding same when seat cushioning and outer layers are taken into account.

It will be understood that reference to the term “perpendicular” orientation with regard to the components is an approximation and angling of the components to be from between 75-100 degrees is contemplated herein and represents an embodied aspect of the invention.

In other aspects, the composite chair framework structure further comprises at least two strength reinforced elbow joints, each elbow joint fixing a first and second beam respectively of said first set of at least two beams to a first and second beam, respectively of said second set of at least two beams and maintaining said joint between the first and second beams respectively of said first set of beams and second set of beams substantially at an angle of about 90 degrees even under applied significant forces.

In some embodiments, the term “elbow joint” refers to an L-shaped structure, which affixes each end of the “L” shape to the first and second beam, respectively. In other embodiments, the term “elbow joint” refers to a larger structure, that comprises an “L” shape incorporated in the larger structure. For example, and in some embodiments, the term “elbow joint” also encompasses a structure similar to a right triangle containing structure, whereby the hypotenuse of the triangular structure further supports the “L” shaped axes, and thus, the structure is still considered an “elbow joint”, since these axes may in turn be affixed to the first and second beam, respectively.

It will be appreciated that any reinforced structure used to join the first and second beams as herein described to affix same at substantially an angle of 90 degrees to support the structural integrity of a framework as herein described is to be understood as being considered as part of this invention.

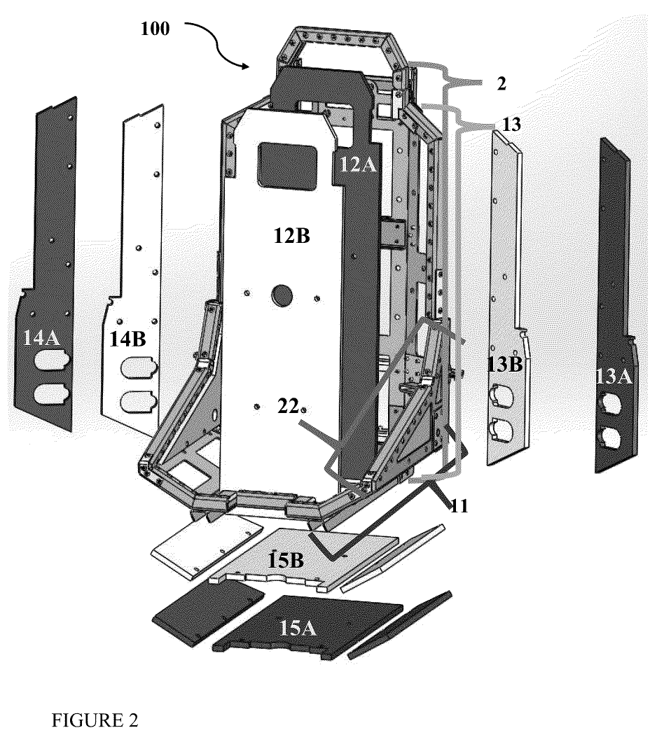

FIG. 2 provides a further non-limiting exploded view highlighting certain aspects of the impact- and blast-resistance improved aircraft pilot chair embodied in FIG. 1, and is also further described hereinbelow. In this figure, as well, the first set of beams (2) are shown in a posterior aspect of the drawing, as being connected to a second set of beams (11) also annotated in the FIG.

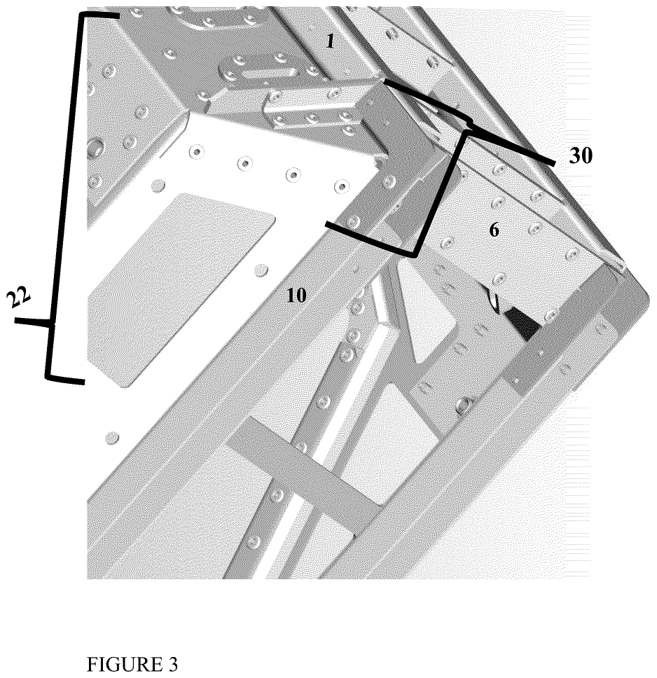

Referring to FIG. 3, for example, a non-limiting illustration of a strength reinforced elbow joint 30 is depicted, connecting one of a pair of first beams 1 with one of a pair of second beams 10. As described hereinabove, the elbow joint accommodates joining a first beam from the first set of beams to a second beam, from the second set of beams, to stabilize joining of same and in some aspects, the angle between the back and seat support is not a perfect 90 degrees, and such angle will be understood to be a rough/approximation by which the two sets of beams respectively abut or join each other, while clearly allowing for further angling of the components, as permissible, for example to provide an adjusted angle to accommodate the needs and comfort of the seat occupant and to accommodate additional “tolerance” regarding same when seat cushioning and outer layers are taken into account.

It will be understood that reference to the elbow joint orientation will permit fastening/fixing/providing joining of the components at an approximation and angling of the components to be from between 75-110 degrees, and any reasonable approximation of this angled range is contemplated herein and represents an embodied aspect of the invention.

The framework of the impact- and blast-resistance improved aircraft pilot chair of this invention will comprise a means to accommodate additional components of the back and seat support as is conventional in the art and as described further somewhat, as well hereinbelow. It will be appreciated that any conventional material, layer, and aspect known in the art as suitable for inclusion in aircraft piloting crew seats in terms of the back and seat support that can accommodate the described components of the framework structure may be included herein and is to be considered as part of the invention.

In addition to the strengthening beams, it is noted that the framework back and seat components accommodate inclusion of panels comprising composite armored element containing assemblies which are fixedly attached to at least a portion of the back and seat support components of the framework structure, to provide additional protection to the occupant as described further herein.

The impact- and blast-resistance improved aircraft pilot chair framework structure of the invention will further comprise laterally extending, angled side protection framework components, which loosely frame and facilitate attachment of side protective panels to the impact- and blast-resistance improved aircraft pilot chair of this invention.

Referring to FIGS. 2, 3 the laterally extending, angled side protection framework components of the invention may comprise upper and lower components, such as, for example, elements 13 and 22, to which side protective panels (13A/B) comprising composite armored element containing assemblies which are fixedly attached to at least a portion of the side protective panels and optionally a backing reinforced layer, for example, a steel backing for same.

In some aspects of the impact- and blast-resistance improved aircraft pilot chair of the invention, the back support component may comprise at least one connecting beam, which connecting beam is fixedly positioned at each terminus to abut or join a portion of the first set of at least two beams and which connecting beam promotes fixedly positioning of the impact- and blast-resistance improved aircraft pilot chair within a desired location in the aircraft.

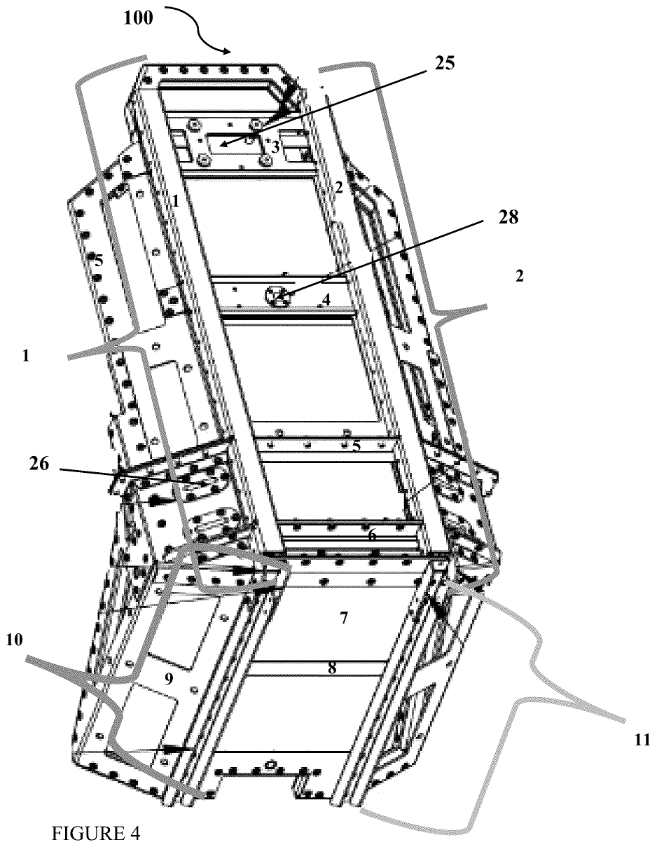

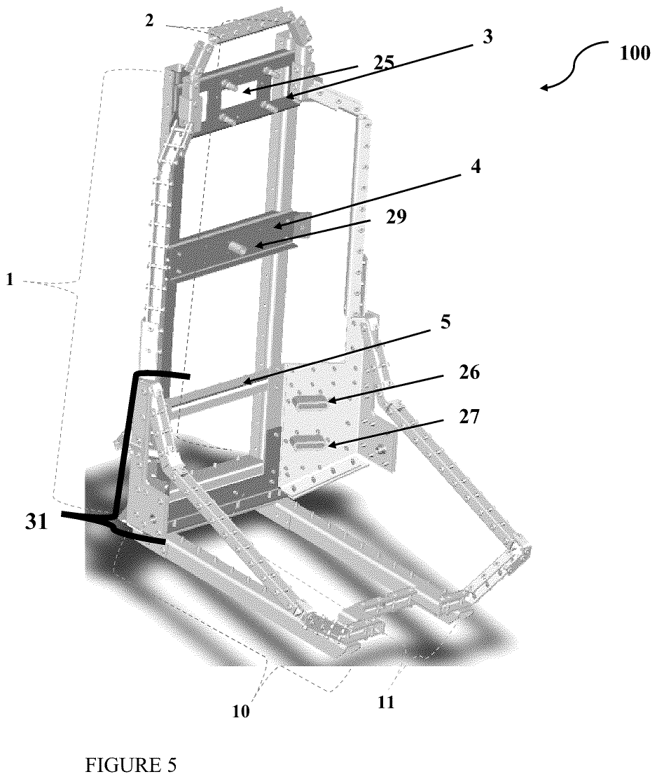

Referring for example to FIGS. 1, 4-5, non-limiting illustrative examples of a connecting beam can be seen at elements 3 or 4 or 5 or 6.

It will be appreciated that such connecting beams may also be positioned between the second set of at least two beams, as part of the seat component supportive element of the framework structure, for example as depicted in element 8 in FIG. 4.

In some aspects, and representing an embodiment of the invention, the connecting beam which promotes fixedly positioning of the chair comprises a steel reinforced access window 28, 29 through which a locking mechanism can be inserted to fixedly position said impact- and blast-resistance improved aircraft pilot chair within a desired location in the aircraft.

In other aspects, the back support component may comprise a safety harness access window 25, through which a safety harness may be securely introduced, to securely support the pilot, and in some aspects, the safety harness access window is reinforced with steel components. According to this aspect, and in some embodiments, the safety harness access window may be located within a connecting beam 3, for example as depicted in FIGS. 1, 4-5, describing non-limiting examples of same.

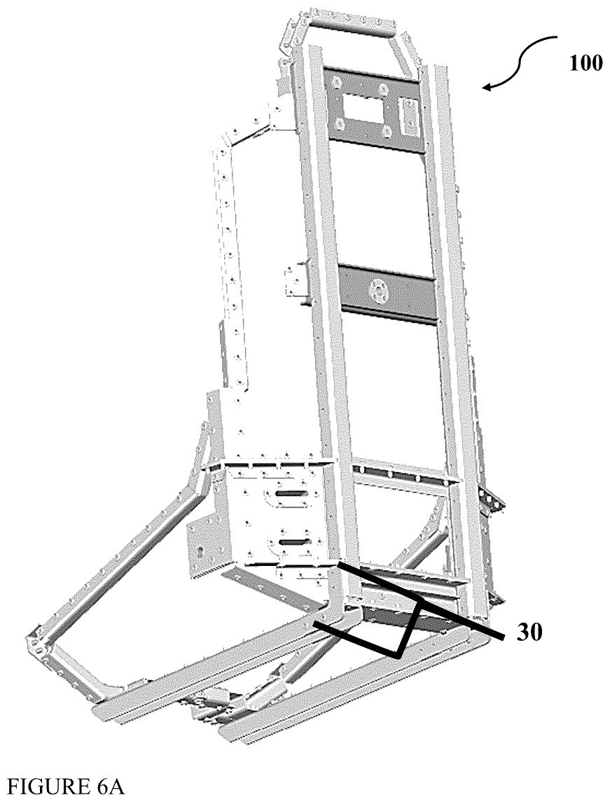

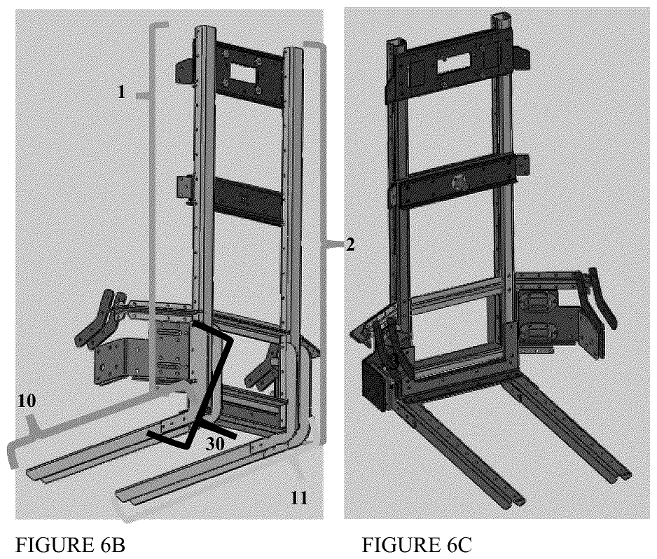

FIGS. 6A-6C highlight in some embodied aspects, the minimal framework elements of the impact- and blast-resistance improved aircraft pilot chair of this invention, including first and second sets of beams (1,2 ad 10, 11) respectively, the elbow joining (30) and additional cross beam supports and safety harness attachment points/pass through windows, as depicted in the figure.

In some embodiments of the invention, the framework structure further comprises one or more safety harness access windows 26, 27 positioned within each of laterally extending, angled side protection framework components, for example as depicted in FIGS. 1, 4-5, which access windows may also be structurally reinforced, for example, to contain a steel reinforcing structure and the like.

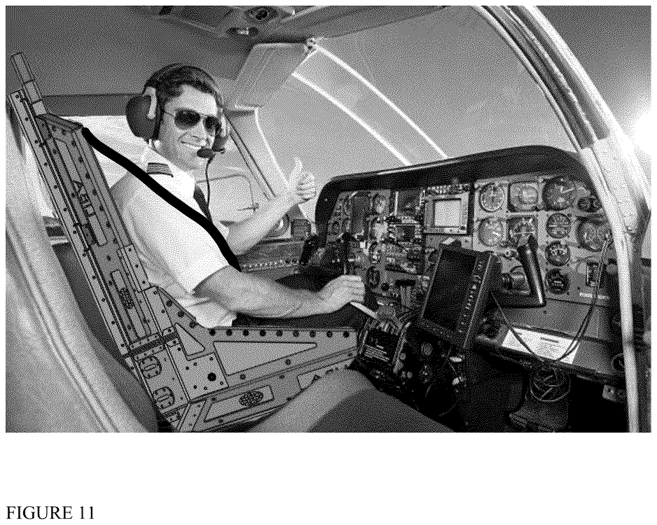

In some embodiments the impact- and blast-resistance improved aircraft pilot chair of the invention will comprise a framework structure scaled to accommodate the size of the pilot, in terms of the length of the first and second set of beams, distance between the beams, or combination thereof. In some embodiments, the thickness of each of the first or second set of beams or combination thereof may also reflect being scaled to accommodate the size of the pilot, for example, as may be appreciated in FIG. 11.

In some embodiments, thickness of the first and second set of beams, the thickness of the laterally extending, angled side protection framework components, dimensions of the composite armored element containing assemblies or a combination thereof is adjusted in consideration of the potential projectile size and warhead capacity to which the aircraft may be exposed.

According to this aspect and in some embodiments, the steel or titanium composition of the first and second set of beams, the laterally extending, angled side protection framework components or a combination thereof may be adjusted in consideration of the potential distortional forces to which the framework structure in the aircraft may be exposed.

According to some embodiments, the metal parts for inclusion in the framework structure components as herein described, will constitute a composite such that certain elements may make use of lighter elements such as aluminum, which in turn reduce the overall weight of the framework components, while not negatively impacting the strength standards of the chairs of the invention. For example, and in some aspects, aluminum is used as a major component of the seat framework assembly, which will further accommodate inclusion of the composite armored element containing assemblies, which provides sufficient strength to prevent both penetration and structural deformation of the seat. Advantageously, in this manner, a seat can be provided that enhances occupant safety without compromising the weight requirements in an aircraft.

In some aspects, any element of the impact- and blast-resistance improved aircraft pilot chair framework elements may frame/serve as an attachment for a composite armored element containing assembly as herein described.

In some aspects, the impact- and blast-resistance improved aircraft pilot chair containing composite armored element containing assemblies comprise:
i. a layer of a plurality of high density alumina ceramic bodies, each of said bodies being substantially cylindrical in shape, with at least one convexly curved end face, and each of said bodies having a major axis substantially perpendicular to the axis of its respective curved end face, wherein the ratio D/R between the diameter D of each of said cylindrical bodies and the radius R of curvature of the respectively convexly curved end face of each of said bodies is at least 0.64:1, and wherein said bodies are arranged in a plurality of adjacent rows and columns, the major axis of said bodies being in substantially parallel orientation with each other and substantially perpendicular to an adjacent surface of said panel; or a single internal layer of elements made of ceramic material disposed in a plurality of spaced-apart rows and columns, which are bound and retained in plate form by an elastic material; a majority of said elements having at least one convexly curved end face; an outer impact receiving major surface defined by said convexly curved end faces of said elements for absorbing and dissipating kinetic energy from high-velocity projectiles; said convexly curved end faces of said elements receiving impact from velocity projectiles and absorbing and dissipating kinetic energy therefrom; said elements having a substantially regular polygonal outer surface with the corners of the polygon being eliminated to form rounded corners; a majority of each of said elements being in direct contact with six adjacent elements in the same layer to provide mutual lateral confinement there between to trap said high-velocity projectiles; a valley space being defined between three adjacent elements, said valley space being substantially smaller than a valley space defined by three cylindrical elements having a diameter the same as said polygonal elements with rounded corners; and a plurality of said elements defining an opening extending into said element from a surface opposite to said outer impact receiving convexly cured end face of said element to reduce the weight per area thereof.

According to this aspect, and in some embodiments, one of the first and second end faces of said ceramic elements is disposed substantially opposite to the outer impact receiving major surface and is spherical and in some embodiments, the one of the first and second end faces of the ceramic elements is disposed opposite said impact receiving major surface and is convexly curved and wherein a ratio D/R between the diameter of the body and a radius of curvature of the one of the first and second end faces disposed opposite the outer impact receiving major surface is between about 0.28:1 and 0.639:1.

In some embodiments, according to this aspect, the one of the first and second end faces of the ceramic elements disposed substantially opposite to the outer impact receiving major surface is in a form of an outwardly tapered truncated cone.

In some embodiments, according to this aspect, a majority of the elements have at least one convexly-curved end face oriented to substantially face in a direction of the outer impact receiving major surface.

In some embodiments, according to this aspect, the elements have at least one axis of at least 9 mm.

In some embodiments, according to this aspect, the elements have at least one axis of at least 20 mm.

In some embodiments, according to this aspect, each of the elements is formed of a ceramic material selected from the group consisting of sintered oxide, nitrides, carbides and borides of alumina, magnesium, zirconium, tungsten, molybdenum, titanium and silica.

In some embodiments, according to this aspect, each of the elements is formed of a material selected from the group consisting of alumina, boron carbide, boron nitride, titanium diboride, silicon carbide, silicon oxide, silicon nitride, magnesium oxide, silicon aluminum oxynitride and mixtures thereof.

In some embodiments, according to this aspect, a plurality of the elements have a channel extending inwardly from said one of the first and second end faces disposed opposite said outer impact receiving major surface to reduce the weight per area thereof.

In some aspects, the composite armored element containing assemblies comprise high density ceramic elements or ceramic bodies, having a chemical content or geometry and size such that the arrangement of the elements in an array serves to protect or mitigate the forces and/or damage from penetrating projectiles to which the aircraft is exposed.

Surprisingly, it has now been found that inclusion of the armored element containing assemblies as herein described, when coupled with the framework elements, can significantly and consistently protect or mitigate the applied forces and/or damage from penetrating projectiles to which the aircraft is exposed.

In some aspects, the armored element containing assemblies as herein described may comprise any appropriate armored element containing assemblies comprising high density ceramic elements or ceramic bodies, for example as described in U.S. Pat. Nos. 5,763,813, 5,972,819, 6,203,908, 6,112,635, 6,408,734, 6,289,781, 6,624,106, 6,575,075, 6,497,966, 6,860,186, 7,117,780, 7,603,939, 8,281,700, 8,012,897, 7,383,762, or 7,402,541, each and every one of which is hereby incorporated herein in its entirety.

In some embodiments, the armored element containing assemblies as herein described may comprise a single internal layer of high density ceramic elements, said elements having an Al₂O₃ content of at least 93%, and a specific gravity of at least 2.5 and retained in panel form by a solidified material which is elastic at a temperature below 250° C.; the majority of said elements each having a part of a major axis of a length of in the range of about 3-12 mm and being bound by said solidified material in a plurality of superposed rows.

In some embodiments, the armored element containing assemblies as herein described specifically envisioned for incorporation include those as described in U.S. Pat. Nos. 5,972,819 or 7,603,939 or a combination thereof. In some embodiments, the armored element containing assemblies as herein described specifically envisioned for incorporation include those as described in U.S. Pat. Nos. 5,972,819, 6,112,635, 7,603,939, 8,281,700, 8,012,897, 7,402,541, 7,383,762 or any combination thereof.

In some aspects, when combining aluminum oxide with other oxides within specific parameter ratios, there is achieved an exceptional rise in the homogenity of the produced product in terms of parametric tolerance based on crush point studies of geometric bodies produced therefrom after sintering. Thus, it has been found that by using raw materials in which the chemical compositions fall within a specific range and forming them into geometric sintered shapes, homogeneity of performance and quantitatively and qualitatively superior activity is achieved.

In some embodiments, the armored element containing assemblies as herein described may comprise a sintered, alumina ceramic product comprising about 90-97.5 w/w % Al2O3, about 0.5-1.0 w/w % MgO, about <0.05-1.0 w/w % SiO2, about 4.5-7.5 w/w % ZrO2 and about 0.07-0.13 w/w % HfO2.

In some embodiments, the armored element containing assemblies as herein described may comprise a sintered, alumina ceramic product, comprising at least 0.585 w/w % MgO, 90 w/w % Al2O3, <0.05 w/w % SiO2, 4.5 w/w % ZrO2 and 0.075 w/w % HfO2.

In some embodiments, the armored element containing assemblies as herein described may comprise a sintered, alumina ceramic products according to the present invention, comprise up to 1.0 w/w % MgO, 97.5 w/w % Al2O3, 1 w/w % SiO2, 7.5 w/w % ZrO2 and 0.125 w/w % HfO2.

In some embodiments, the armored element containing assemblies as herein described may comprise a sintered, alumina ceramic product, comprising about 0.6 w/w % MgO, 93 w/w % Al2O3, <0.05 w/w % SiO2, 6 w/w % ZrO2 and 0.1 w/w % HfO2.

In some embodiments, the armored element containing assemblies can preferably include further minor amounts of additional oxides, selected from the group consisting of Na2O, P2O5, K2O, CaO, TiO2, Fe2O3, CuO, ZnO, BaO, Y2O3 and mixtures thereof.

In some embodiments, the armored element containing assemblies as herein described may comprise a sintered, alumina ceramic product comprising about 0.6 w/w % MgO, 92.62 w/w % Al2O3, <0.05 w/w % Sio2, 6 w/w % ZrO2, 0.1 w/w % HfO2, 0.2 w/w % Na2O, 0.02 w/w % P2O5, 0.01 w/w % K2O, 0.1 w/w % CaO, 0.01 w/w % TiO2, 0.02 w/w % Fe2O3, 0.2 w/w % CuO, 0.02 w/w % ZnO, 0.5 w/w % BaO, and 0.04 w/w % Y2O3.

In some embodiments, the armored element containing assemblies as herein described may comprise a sintered, alumina product comprising about 90-97.5 w/w % Al2O3, about 0.5-1.0 w/w % MgO, about <0.05-1.0 w/w % SiO2, about 4.5-7.5 w/w % ZrO2 and about 0.07-0.13 w/w % HfO2.

In some embodiments, the armored element containing assemblies as herein described may comprise a single internal layer of high density ceramic elements which are directly bound and retained by a solidified material such that the elements are arranged in a single layer of adjacent rows and columns wherein a majority of each of said elements is in direct contact with at least six adjacent elements, wherein each of said elements is made from a sintered, alumina product comprising about 90-97.5 w/w % Al2O3, about 0.5-1.0 w/w % MgO, about <0.05-1.0 w/w % SiO2, about 4.5-7.5 w/w % ZrO2 and about 0.07-0.13 w/w % HfO2 and there is less than a 30% difference between the crushing point of adjacent elements.

In some embodiments, the armored element containing assemblies as herein described may comprise a layer of a plurality of high density alumina ceramic bodies, each of said bodies being substantially cylindrical in shape, with at least one convexly curved end face, and each of said bodies having a major axis substantially perpendicular to the axis of its respective curved end face, wherein the ratio D/R between the diameter D of each of said cylindrical bodies and the radius R of curvature of the respectively convexly curved end face of each of said bodies is at least 0.64:1, and wherein said bodies are arranged in a plurality of adjacent rows and columns, the major axis of said bodies being in substantially parallel orientation with each other and substantially perpendicular to an adjacent surface of said panel; wherein a majority of each of said elements is in contact with at least 4 adjacent elements, the weight of said panel does not exceed 45 kg/M2.

In some embodiments, the armored element containing assemblies as herein described may comprise a single internal layer of high density ceramic elements which are directly bound and retained within the framework structure by a solidified material such that the elements are arranged in a single layer of adjacent rows and columns wherein a majority of each of said elements is in direct contact with at least six adjacent elements, wherein each of said elements is made from a sintered, alumina product comprising about 90-93 w/w % Al2O3, about 0.5-1.0 w/w % MgO, up to about [<] 1.0 w/w % SiO2, about 4.5-7.5 w/w % ZrO2 and about 0.07-0.13 w/w % HfO2 and there is less than a 30% difference between the crushing point of adjacent elements.

In some embodiments, the armored element containing assemblies as herein described may comprise a single internal layer of high density ceramic elements which are directly bound and retained within the framework structure by a solidified material such that the elements are bound in a plurality of adjacent rows, wherein the elements have an Al2O3 content of at least 93% and a specific gravity of at least 2.5, the majority of the elements each have at least one axis of at least 12 mm length, said one axis of substantially all of said elements being in substantially parallel orientation with each other and substantially perpendicular to an adjacent surface of said plate, and wherein a majority of each of said elements is in direct contact with six adjacent elements and said solidified material and said plate are elastic.

In some embodiments, the armored element containing assemblies as herein described may comprise a single internal layer of elements which are directly bound and retained within the framework structure by a solidified material such that the elements are bound in a plurality of adjacent rows, characterized in that the elements have a specific gravity of at least 2 and are made of a material selected from the group consisting of glass, sintered refractory material, ceramic material which does not contain aluminum oxide and ceramic material having an aluminium oxide content of not more than 80%, the majority of the elements each have at least one axis of at least 3 mm length and are bound by said solidified material in said single internal layer of adjacent rows such that each of a majority of said elements is in direct contact with at least 6 adjacent elements in the same layer to provide mutual lateral confinement therebetween, said elements each have a substantially regular geometric form and said solidified material and said plate are elastic.

In some embodiments, the armored element containing assemblies as herein described may comprise a layer of a plurality of high density alumina ceramic bodies, each of said bodies being substantially cylindrical in shape, with at least one convexly curved end face, and each of said bodies having a major axis substantially perpendicular to the axis of its respective curved end face, wherein the ratio D/R between the diameter D of each of said cylindrical bodies and the radius R of curvature of the respectively convexly curved end face of each of said bodies is at least 0.64:1, and wherein said bodies are arranged in a plurality of adjacent rows and columns, the major axis of said bodies being in substantially parallel orientation with each other and substantially perpendicular to an adjacent surface of said panel; wherein a majority of each of said elements is in contact with at least 4 adjacent elements, the weight of said panel does not exceed 45 kg/M2.

In some embodiments, the armored element containing assemblies as herein described may comprise a single internal layer of high density ceramic elements which are directly bound and retained within the framework structure by a solidified material such that the elements are arranged in a single layer of adjacent rows and columns wherein a majority of each of said elements is in direct contact with at least six adjacent elements, wherein each of said elements is made from a sintered, alumina product comprising about 90-93 w/w % Al2O3, about 0.5-1.0 w/w % MgO, up to about [<] 1.0 w/w % SiO2, about 4.5-7.5 w/w % ZrO2 and about 0.07-0.13 w/w % HfO2 and there is less than a 30% difference between the crushing point of adjacent element.

In some embodiments, the armored element containing assemblies as herein described may comprise a single internal layer of high density ceramic elements which are directly bound and retained within the framework structure by a solidified material such that the elements are bound in a plurality of adjacent rows, wherein the elements have an Al2O3 content of at least 93% and a specific gravity of at least 2.5, the majority of the elements each have at least one axis of at least 12 mm length, said one axis of substantially all of said elements being in substantially parallel orientation with each other and substantially perpendicular to an adjacent surface of said plate, and wherein a majority of each of said elements is in direct contact with six adjacent elements and said solidified material and said plate are elastic.

In some embodiments, the armored element containing assemblies as herein described may comprise a single internal layer of elements which are directly bound and retained within the framework structure by a solidified material such that the elements are bound in a plurality of adjacent rows, characterized in that the elements have a specific gravity of at least 2 and are made of a material selected from the group consisting of glass, sintered refractory material, ceramic material which does not contain aluminum oxide and ceramic material having an aluminium oxide content of not more than 80%, the majority of the elements each have at least one axis of at least 3 mm length and are bound by said solidified material in said single internal layer of adjacent rows such that each of a majority of said elements is in direct contact with at least 6 adjacent elements in the same layer to provide mutual lateral confinement therebetween, said elements each have a substantially regular geometric form and said solidified material and said plate are elastic.

In some embodiments, the elements are formed of a ceramic material selected from the group consisting of sintered oxide, nitrides, carbides and borides of alumina, magnesium, zirconium, tungsten, molybdenum, titanium and silica.

In some embodiments, each of the elements is formed of a material selected from the group consisting of alumina, boron carbide, boron nitride, titanium diboride, silicon carbide, silicon oxide, silicon nitride, magnesium oxide, silicon aluminum oxynitride and mixtures thereof.

In some embodiments, the armor assembly consists essentially of a single internal layer of a plurality of high density ceramic bodies directly bound and retained within the framework structure by a solidified material, having a specific gravity of at least 2 and being made of a material selected from the group consisting of ceramic material which does not contain aluminium oxide and ceramic material having an aluminium oxide content of not more than 80%, wherein each of the bodies are substantially cylindrical in shape, with at least one convexly curved end face, and each of the bodies have a major axis substantially perpendicular to the axis of its respective curved end face, wherein the ratio D/R between the diameter D of each of the cylindrical bodies and the radius R of curvature of the respectively convexly curved end face of each of the bodies is at least 0.64:1, and wherein the bodies are arranged in a plurality of adjacent rows and columns, the major axis of said bodies being in substantially parallel orientation with each other. with the outer surface facing the impact side and ceramic bodies are arranged in a plurality of adjacent rows, the cylinder axis of said bodies being substantially parallel with each other and substantially perpendicular to the surfaces of the panel with the convexly curved end faces directed to the outer surface and the composite armor further comprising an inner layer adjacent the inner surface of said panel, where the inner layer is formed from a plurality of adjacent layers, each layer comprising a plurality of unidirectional coplanar anti-ballistic fibers embedded in a polymeric matrix, the fibers of adjacent layers being at an angle of between about 45° to 90° to each other.

In other embodiments, the within the framework structure accommodates/supports inclusion of a layer of a plurality of high density ceramic bodies, having a specific gravity of at least 2 and being made of a material selected from the group consisting of ceramic material which does not contain aluminium oxide and ceramic material having an aluminium oxide content of not more than 80%, each of said bodies being substantially cylindrical in shape, with at least one convexly curved end face, and each of said bodies having a major axis substantially perpendicular to the axis of its respective curved end face, wherein the ratio D/R between the diameter D of each of said cylindrical bodies and the radius R of curvature of the respectively convexly curved end face of each of said bodies is at least 0.64:1, and wherein said bodies are arranged in a plurality of adjacent rows and columns, the major axis of said bodies being in substantially parallel orientation with each other and substantially perpendicular to an adjacent surface of the framework structure.

In some embodiments, the armored element containing assemblies as herein described may further comprise a fiber-reinforced matrix.

In embodiments of the invention the fiber in the fiber-reinforced matrix may consist essentially of a material selected from the group consisting of: poly-paraphenylene terephthalamide, stretch-oriented high density polyethylene, stretch-oriented high density polypropylene, stretch-oriented high density polyester, a polymer based on pyridobisimidazole, and silicate glass. Presently preferred embodiments of the invention include fiber-reinforced materials having high density stretch-oriented polypropylene fibers consolidated by heat and pressure in a lower density polypropylene polymer.

In some aspects, the armored element containing assemblies comprising a fiber-reinforced matrix may comprise a composite material, for example containing fibers and resin, such as, but not limited to, carbon fiber reinforced epoxy prepreg, glass fiber reinforced epoxy prepreg, and other combinations of fibers and resins or matrix materials. Such combinations include glass, carbon, boron, Kevlar™, aramid, and other fibers or fiberous materials along with epoxy, polyester, vinylester, nylon, ABS, PPS, PEEK, and other thermosetting or thermoplastic matrix materials. In one embodiment, use of composites comprising carbon fibers or nanotubes is contemplated herein.

In another embodiment, composite structures are specifically envisioned as being components of the framework structure, which may incorporate any of the composite material as herein described, as will be appreciated by the skilled artisan, and that same is not only limited to incorporation in the armored element containing assemblies of this invention.

In some aspects, such armored element containing assemblies comprising a fiber-reinforced matrix may constitute a “laminate”, and may further comprise additional layers to promote incorporation within the framework structure and/or promoting attachment thereto.

For example, and referring to FIG. 2, panels 12A, 12B, 15A, 15B, 13A, 13B, and 14A and 14B schematically depict non-limiting depictions of both the armored element containing assemblies (B panels described) and backing layers (A panels described), which can be further reinforced with another strength promoting metal panel, or securing panel onto which for example, upholstery or other desired elements of the chair is attached/joined, or in other aspects, the A panels may constitute the armored element containing assemblies, and the B panels may include a second strength promoting metal panel, etc. or vice versa.

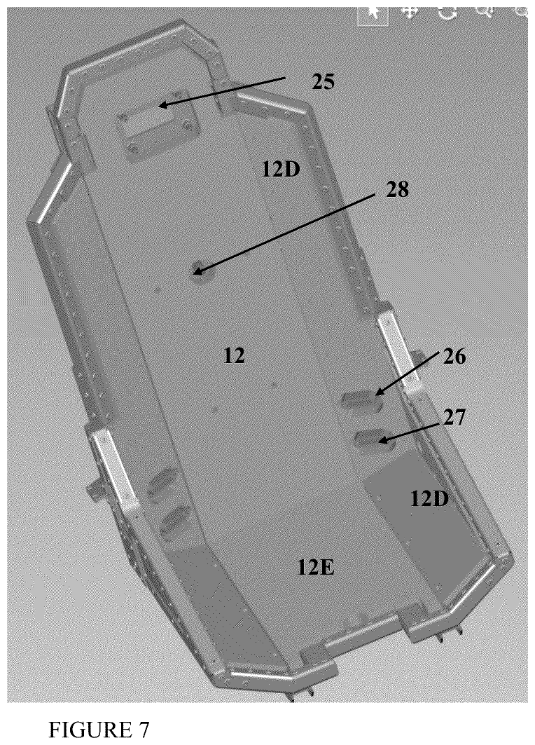

FIG. 7 provides a schematic depiction of a filled in version of an embodied, non-limiting impact- and blast-resistance improved aircraft pilot chair of this invention, where the components as described herein are all present, but the overall view to the user is that of a typical if apparently lighter weight chair frame profile.

It will be appreciated that one or more layers of strength promoting metal panels or armored element containing assemblies will be incorporated in the impact- and blast-resistance improved aircraft pilot chairs of the invention, the choice in number, composition, thickness, size etc. which may reflect the anticipated circumstances to which the aircraft may be exposed, size of the aircraft, cargo carried in the aircraft, etc. any embodiment of which is to be considered as part of this invention.

This invention therefore also contemplates any aircraft comprising an impact- and blast-resistance improved aircraft pilot chair as herein described. In preferred aspects, the aircraft is a helicopter.

In some embodiments of the present invention, the impact- and blast-resistance improved aircraft pilot chair as herein described is thought to be equally applicable in various other environments, such as aircraft passenger (main cabin area) seats, flight attendant seats, ejection seats of fighter aircraft, automobiles, including trucks, racing cars, buses, watercraft, trains and the like.

In some aspects, while embodiments of the present invention are thought to be particularly useful in aircraft and specifically in the cockpit, the present invention is not limited to application within any particular environment.

Additionally, while embodiments of the present invention are described with reference to a particular lamination methodology, those skilled in the field of composites will readily understand that various other composite processing technologies may be employed, including, but not limited to thermoset resin injection pultrusion (RIP), thermoplastic pultrusion, prepreg formation, sheet/bulk molding compounds (SMC/BMC) compression molding, injection-compression molding, preforming of thermoformable fabrics, compression molding of thermoplastic composites, transfer molding, squeezing flow rheology, wet layup, prepreg, RTM, VARTM, or other standard composite manufacturing processes.

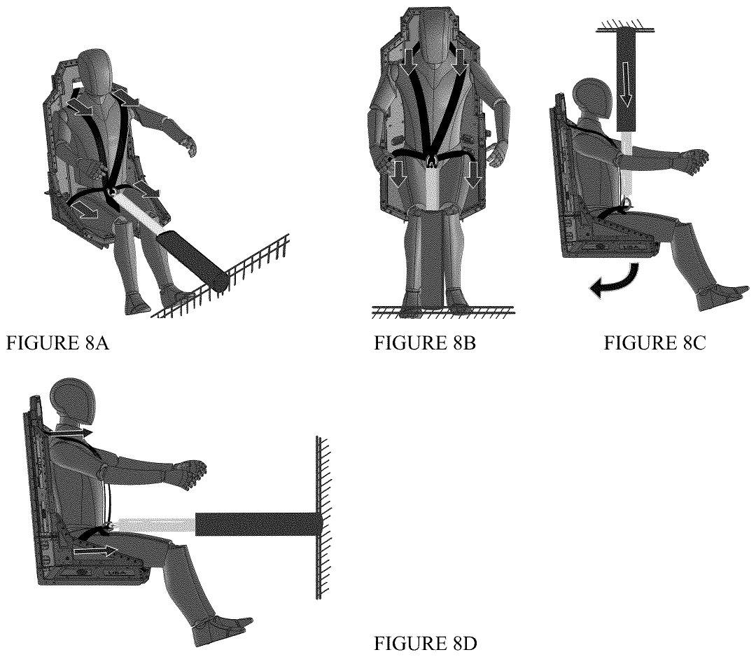

Referring to FIG. 8, uniquely, the present invention provides an impact- and blast-resistance improved aircraft pilot chair, which outperforms in test scenarios, where a significantly high amount of force is applied. FIGS. 8A-8D depict an experimental system for a test impact- and blast-resistance improved aircraft pilot chair of this invention, identifying the direction of force applied in the experimental system.

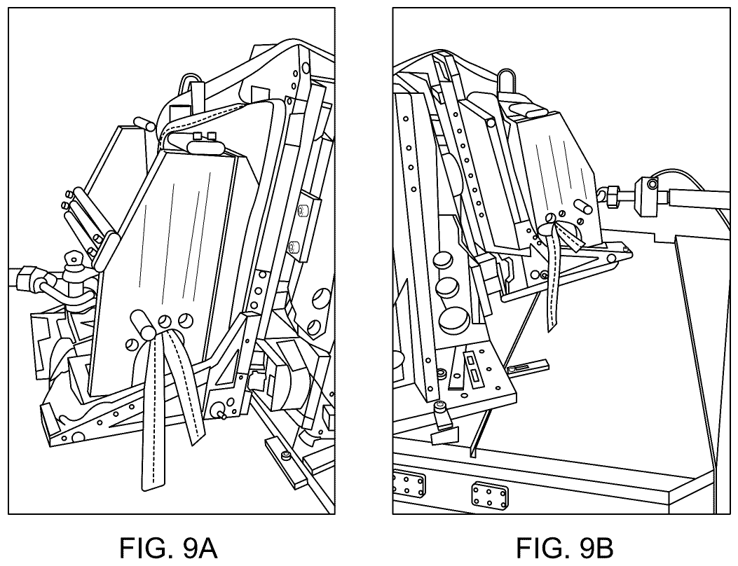

According to these embodiments, downward loads (8B-8C) and lateral loads/forces (8A and 8D) were applied, to determine the load/force capacity of the embodied chair and FIGS. 9A and 9B are photographs taken when conducting such test on an embodied impact- and blast-resistance improved chair of the invention, whereby despite application of more than 21,000 pounds of force, no structural compromise was evident, as also shown in the results in FIG. 10.

In addition to the features already described herein with regard to the impact- and blast-resistance improved aircraft pilot chairs of this invention, it was also found that it is possible to provide significant protection, by shielding a desired location/personnel, etc. by providing a framework structure as herein described at a protective distance from a potential target, whereby the impact-facing surface should contain elements of the framework structure, so that incoming projectiles, if they are going to reach a target, detonate at a significant distance from the sensitive target location zone.

According to this aspect, and in some embodiments, a relatively easily deployed strong framework structure should be sufficient to result in the controlled detonation, providing support and protection to the targets being shielded thereby.

Accordingly, this invention also provides an impact- and blast-resistance improved passive protection structure, said passive protection structure comprising:
a. a composite framework passive protection structure configured for facing an anticipated impact direction for reducing the damage and/or fatality associated with an incoming projectile, including, inter alia, reducing the damage and/or fatality associated with an impact or blast triggering of an incoming projectile, wherein said passive protection structure comprises:
   i. a first set of at least two beams forming a long axis of said frame, wherein each of said at least two beams are from 10-100 mm in width and from 0.5-20 mm thickness and said beams are positioned at a distance from each other, wherein said beams are comprised of steel, aluminum, titanium or a composite of same and wherein said first set of at least two beams constitutes a part of or is fixedly attached to said long axis of said frame component; and
   ii. a second set of at least two beams positioned substantially perpendicularly with respect to said first set, wherein each of said at least two beams are from 10-100 mm in width and from 0.5-20 mm thickness and wherein a first beam of said second set is fixedly positioned at its terminus to abut or join a terminus of a first beam of said first set and a second beam of said second set is fixedly positioned at its terminus to abut or join a terminus of a second beam of said first set and wherein said second set of at least two beams constitutes a part of or is fixedly attached to a static structure; and
   iii. at least two strength reinforced elbow joints, each elbow joint fixing a first and second beam respectively of said first set of at least two beams to a first and second beam, respectively of said second set of at least two beams and maintaining said joint between the first and second beams respectively of said first set of beams and second set of beams substantially at an angle of about 90 degrees even under applied significant forces; and
   iv. optionally laterally extending, angled protection framework components, which loosely frame the boundaries that the framework structure protects; and
b. optionally a composite armored layer containing assemblies positioned at a distance from said framework structure, providing further protection to anything located underneath the armored layer.

According to this aspect and in some embodiments, the impact facing surface, in addition to being supported by the strong series of long axis beams to provide the higher impact engaging surface, shielding the targets there underneath, also may comprise cross beams and other modified cross connecting structures, that as well, may participate in engaging any incoming projectile with detonation capability, to ensure detonation occurs at a distance from the target.

In other embodiments, according to this aspect, the composite armored layer containing assemblies positioned at a distance from the impact facing surface, are still at a distance from the target site, effectively shielding the target located there underneath, for example. It will be appreciated that the composite armored layer containing assemblies as herein described may also be positioned laterally, to provide lateral shielding of the target and not only apical to the target.

In still further embodiments, the invention provides a method of improving the impact- and blast-resistance of a structure, the method comprising equipping the structure potentially exposed to a blast or penetrating impact to comprise the impact- and blast-resistance improved framework structure of this invention, including in any embodiment as described herein with respect to same.

While the invention will be described in conjunction with the illustrated embodiments, it will be understood that they are not intended to limit the invention to those embodiments. On the contrary, the invention is intended to cover all alternatives, modifications, and equivalents that may be included within the invention as defined by the appended claims.

### EXAMPLES

### Materials and Methods

### Example 1

### Construction of Embodied Impact- and Blast-Resistance Improved Aircraft Pilot Chair of This Invention

It will be understood by the skilled artisan how to construct and produce the embodied composite impact- and blast-resistance improved aircraft pilot chairs as herein described.

For example, and in some embodiments, elements of the frames can be prepared as a integral bodies, or the various elements may be provided by any of the following: bolting, welding, external wrapping and other methods as known to the artisan.

The composite armored element containing assemblies may be prepared by any of the methods as described in U.S. Pat. Nos. 5,763,813, 5,972,819, 6,203,908, 6,112,635, 6,408,734, 6,289,781, 6,624,106, 6,575,075, 6,497,966, 6,860,186, 7,117,780, 7,603,939, 8,281,700, 8,012,897, 7,383,762, or 7,402,541, each and every one of which is hereby incorporated herein in its entirety, which in turn may be attached to the framework structure via, bolting, welding, etc., as will be appreciated by the skilled artisan.

### Example 2

### Superior Protection Afforded by the Embodied Impact- and Blast-Resistance Improved Aircraft Pilot Chair of This Invention

In order to evaluate the embodied composite impact- and blast-resistance improved aircraft pilot chairs of the invention, it was of interest to determine whether the chair framework composition could withstand active significant forces applied to the structure and further assess whether any structural compromise was evident.

Toward this end, the framework structure/chair was subjected to increasing applied forces, for example, as described in: Hughes K, Gulavani O, Vuyst TD, Vignjevic R. Explicit dynamic formulation to demonstrate compliance against quasi-static aircraft seat certification loads (CS25.561)—Part II: Influence of body blocks. Proceedings of the Institution of Mechanical Engineers, Part G: Journal of Aerospace Engineering. 2014; 228(10):1890-1903. doi:10.1177/0954410013506415.

FIGS. 8A-8D depict the various applied force directions included in the evaluation, and FIGS. 9A and 9B depict an embodied tested chair in this context, before (9A) and under applied force (9B), showing no structural compromise whatsoever. FIG. 10 plots the results of this study, where the experiment was halted after 21,000 pounds of force was applied and no structural compromise was detected in any aspect of the framework structure.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be understood by those skilled in the art that various changes in form and details may be made therein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims.

All publications, patents, and patent applications mentioned herein are hereby incorporated by reference in their entirety as if each individual publication or patent was specifically and individually indicated to be incorporated by reference. In case of a conflict between the specification and an incorporated reference, the specification shall control. Where number ranges are given in this document, endpoints are included within the range. Furthermore, it is to be understood that unless otherwise indicated or otherwise evident from the context and understanding of one of ordinary skill in the art, values that are expressed as ranges can assume any specific value or subrange within the stated ranges, optionally including or excluding either or both endpoints, in different embodiments of the invention, to the tenth of the unit of the lower limit of the range, unless the context clearly dictates otherwise. Where a percentage is recited in reference to a value that intrinsically has units that are whole numbers, any resulting fraction may be rounded to the nearest whole number.

In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g. in Markush group format or the like, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein. Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

1. An impact- and blast-resistance improved aircraft pilot chair, said chair comprising:
a) a composite chair framework structure serving as the scaffolding for the impact- and blast-resistance improved aircraft pilot chair, wherein said framework structure comprises a back support component, a seat component and a side protection component of said pilot chair, comprising;
i) a first set of at least two beams posteriorly affixed to or forming a long axis of said chair frame, wherein each of said at least two beams are from 10-25 mm in width and from 0.5-7 mm thickness and said beams are positioned at a distance from each other, wherein said beams are comprised of steel, aluminum, titanium or a composite of same and wherein said first set of at least two beams constitutes a part of or is fixedly attached to said back support component; and
ii) a second set of at least two beams positioned substantially perpendicularly with respect to said first set, wherein each of said at least two beams are from 10-25 mm in width and from 0.5-7 mm thickness and wherein a first beam of said second set is fixedly positioned at its terminus to abut or join a terminus of a first beam of said first set and a second beam of said second set is fixedly positioned at its terminus to abut or join a terminus of a second beam of said first set and wherein said second set of at least two beams constitutes a part of or is fixedly attached to said seat component; and
iii) at least two strength reinforced elbow joints, each elbow joint fixing a first and second beam respectively of said first set of at least two beams to a first and second beam, respectively of said second set of at least two beams and maintaining said joint between the first and second beams respectively of said first set of beams and second set of beams substantially at an angle of about 90 degrees even under applied significant forces; and
iv) laterally extending, angled side protection framework components, which loosely frame and facilitate attachment of side protective panels; and
b) composite armored element containing assemblies which are fixedly attached to said composite chair framework structure at least to a portion of the area of said back support component, seat component and side protection component of said pilot chair.

2. The impact- and blast-resistance improved aircraft pilot chair of claim 1, wherein said first set of at least two beams posteriorly affixed to or forming a long axis of said chair frame form a U or similar shape.

3. The impact- and blast-resistance improved aircraft pilot chair of claim 1, wherein said second set of at least two beams positioned substantially perpendicularly with respect to said first set forms a U or similar shape.

4. The impact- and blast-resistance improved aircraft pilot chair of claim 1, wherein said back support component may comprise at least one connecting beam, which connecting beam is fixedly positioned at each terminus to abut or join a portion of said first set of at least two beams and which connecting beam promotes fixedly positioning of the impact- and blast-resistance improved aircraft pilot chair within a desired location in the aircraft.

5. The impact- and blast-resistance improved aircraft pilot chair of claim 2, wherein said connecting beam which promotes fixedly positioning of said chair comprises a steel reinforced access window through which a locking mechanism can be inserted to fixedly position said impact- and blast-resistance improved aircraft pilot chair within a desired location in the aircraft.

6. The impact- and blast-resistance improved aircraft pilot chair of claim 1, wherein said back support component may comprise a safety harness access window, through which a safety harness may be securely introduced, to securely support the pilot.

7. The impact- and blast-resistance improved aircraft pilot chair of claim 3, wherein said safety harness access window is reinforced with steel components.

8. The impact- and blast-resistance improved aircraft pilot chair of claim 3, wherein said framework structure further comprises one or more safety harness access windows positioned within each of said laterally extending, angled side protection framework components.

9. The impact- and blast-resistance improved aircraft pilot chair of claim 6, wherein said one or more safety harness access windows positioned within each of said laterally extending, angled side protection framework components are further reinforced with additional steel components.

10. The impact- and blast-resistance improved aircraft pilot chair of claim 1, wherein said framework structure is scaled to accommodate the size of the pilot.

11. The impact- and blast-resistance improved aircraft pilot chair of claim 1, wherein a thickness of said first and second set of at least two beams, a thickness of said laterally extending, angled side protection framework components, dimensions of said composite armored element containing assemblies or a combination thereof is adjusted in consideration of the potential projectile size and warhead capacity to which the aircraft may be exposed.

12. The impact- and blast-resistance improved aircraft pilot chair of claim 9, wherein a steel or titanium composition of said first and second set of at least two beams, said laterally extending, angled side protection framework components or a combination thereof may be adjusted in consideration of the potential distortional forces to which the framework structure in the aircraft may be exposed.

13. The impact- and blast-resistance improved aircraft pilot chair of claim 1, wherein the composite armored element containing assemblies comprise:
i) a layer of a plurality of high density alumina ceramic bodies, each of said bodies being substantially cylindrical in shape, with at least one convexly curved end face, and each of said bodies having a major axis substantially perpendicular to the axis of its respective curved end face, wherein the ratio D/R between the diameter D of each of said cylindrical bodies and the radius R of curvature of the respectively convexly curved end face of each of said bodies is at least 0.64:1, and wherein said bodies are arranged in a plurality of adjacent rows and columns, the major axis of said bodies being in substantially parallel orientation with each other and substantially perpendicular to an adjacent surface of said panel; or a single internal layer of elements made of ceramic material disposed in a plurality of spaced-apart rows and columns, which are bound and retained in plate form by an elastic material; a majority of said elements having at least one convexly curved end face; an outer impact receiving major surface defined by said convexly curved end faces of said elements for absorbing and dissipating kinetic energy from high-velocity projectiles; said convexly curved end faces of said elements receiving impact from high-velocity projectiles and absorbing and dissipating kinetic energy therefrom; said elements having a substantially regular polygonal outer surface with the corners of the polygon being eliminated to form rounded corners; a majority of each of said elements being in direct contact with six adjacent elements in the same layer to provide mutual lateral confinement there between to trap said high-velocity projectiles; a valley space being defined between three adjacent elements, said valley space being substantially smaller than a valley space defined by three cylindrical elements having a diameter the same as said polygonal elements with rounded corners; and a plurality of said elements defining an opening extending into said element from a surface opposite to said outer impact receiving convexly cured end face of said element to reduce the weight per area thereof.

14. The impact- and blast-resistance improved aircraft pilot chair of claim 13, wherein wherein the one of the first and second end faces of said ceramic elements is disposed substantially opposite to the outer impact receiving major surface and is spherical.

15. The impact- and blast-resistance improved aircraft pilot chair of claim 13, wherein the one of the first and second end faces of said ceramic elements is disposed opposite said impact receiving major surface and is convexly curved and wherein a ratio D/R between the diameter of the body and a radius of curvature of the one of the first and second end faces disposed opposite said outer impact receiving major surface is between about 0.28:1 and 0.639:1.

16. The impact- and blast-resistance improved aircraft pilot chair of claim 13, wherein the one of the first and second end faces of said ceramic elements disposed substantially opposite to the outer impact receiving major surface is in a form of an outwardly tapered truncated cone.

17. The impact- and blast-resistance improved aircraft pilot chair of claim 13, wherein a majority of said elements have at least one convexly-curved end face oriented to substantially face in a direction of the outer impact receiving major surface.

18. The impact- and blast-resistance improved aircraft pilot chair of claim 13, wherein said elements have at least one axis of at least 9 mm.

19. The impact- and blast-resistance improved aircraft pilot chair of claim 13, wherein said elements have at least one axis of at least 20 mm.

20. The impact- and blast-resistance improved aircraft pilot chair of claim 13, wherein each of said elements is formed of a ceramic material selected from the group consisting of sintered oxide, nitrides, carbides and borides of alumina, magnesium, zirconium, tungsten, molybdenum, titanium and silica.

21. The impact- and blast-resistance improved aircraft pilot chair of claim 13, wherein each of said elements is formed of a material selected from the group consisting of alumina, boron carbide, boron nitride, titanium diboride, silicon carbide, silicon oxide, silicon nitride, magnesium oxide, silicon aluminum oxynitride and mixtures thereof.

22. The impact- and blast-resistance improved aircraft pilot chair of claim 13, wherein a plurality of said elements have a channel extending inwardly from said one of the first and second end faces disposed opposite said outer impact receiving major surface to reduce the weight per area thereof.

23. An aircraft comprising an impact- and blast-resistance improved aircraft pilot chair of claim 1.

24. The aircraft of claim 23, wherein said aircraft is a helicopter.

25. A method of improving the impact- and blast-resistance of an aircraft pilot chair, said method comprising equipping a pilot chair in said aircraft to comprise the impact- and blast-resistance improved aircraft pilot chair of claim 1, whereby impact resistance of said aircraft pilot chair is improved to withstand application of at least up to about 9 G of applied force.

26. The method of claim 23, wherein said aircraft pilot chair can withstand application of at least up to about 20,000 pounds of horizontal force, or at least up to about 10,000 pounds of vertical force or a combination thereof.

27. The method of claim 23, wherein the composite armored element containing assemblies reduce the damage of small impacting projectiles penetrating said aircraft.

28. The method of claim 23, wherein the composite armored element containing assemblies protect against bullets, shrapnel or a combination thereof, penetrating said aircraft.

29. The method of claim 23, wherein the composite armored element containing assemblies at least partially protect the pilot against the debris arising as a result of an impacting projectile or explosion to which the aircraft is exposed.

30. The method of claim 23, wherein the composite armored element containing assemblies at least partially protect the pilot against the impact of aircraft crash, or aircraft pilot chair ejection.

31. An impact- and blast-resistance improved passive protection structure, said passive protection structure comprising:
a) a composite framework passive protection structure configured for facing an anticipated impact direction for reducing the damage and/or fatality associated with an incoming projectile, including, inter alia, reducing the damage and/or fatality associated with an impact or blast triggering of an incoming projectile, wherein said passive protection structure comprises:
i) a first set of at least two beams forming a long axis of said frame, wherein each of said at least two beams are from 10-100 mm in width and from 0.5-20 mm thickness and said beams are positioned at a distance from each other, wherein said beams are comprised of steel, aluminum, titanium or a composite of same and wherein said first set of at least two beams constitutes a part of or is fixedly attached to said long axis of said frame component; and
ii) a second set of at least two beams positioned substantially perpendicularly with respect to said first set, wherein each of said at least two beams are from 10-100 mm in width and from 0.5-20 mm thickness and wherein a first beam of said second set is fixedly positioned at its terminus to abut or join a terminus of a first beam of said first set and a second beam of said second set is fixedly positioned at its terminus to abut or join a terminus of a second beam of said first set and wherein said second set of at least two beams constitutes a part of or is fixedly attached to a static structure; and
iii) at least two strength reinforced elbow joints, each elbow joint fixing a first and second beam respectively of said first set of at least two beams to a first and second beam, respectively of said second set of at least two beams and maintaining said joint between the first and second beams respectively of said first set of beams and second set of beams substantially at an angle of about 90 degrees even under applied significant forces; and
iv) optionally laterally extending, angled protection framework components, which loosely frame the boundaries that the framework structure protects; and
b) optionally a composite armored layer containing assemblies positioned at a distance from said framework structure, providing further protection to anything located underneath the armored layer.

32. (canceled)
